(19) United States
(12) Patent Application Publication
(10) Pub. No.: US 2026/0138093 A1
(43) Pub. Date: May 21, 2026

(54) DIRECT WATER PURIFICATION SYSTEM WITH AUTOMATIC BACKWASH FUNCTION

(71) Applicant: FLUXTEK INTERNATIONAL CORP., Pingtung City (TW)

(72) Inventors: YEN-TSUN LAI, Pingtung City (TW); SHUN-LI TSAI, Pingtung City (TW)

(73) Assignee: FLUXTEK INTERNATIONAL CORP., Pingtung City (TW)

(21) Appl. No.: 19/001,608

(22) Filed: Dec. 26, 2024

(30) Foreign Application Priority Data
Nov. 21, 2024 (TW) 113144835

(51) Int. Cl. B01D 65/02; B01D 61/02; B01D 61/12; C02F 1/00; C02F 1/44

(52) U.S. Cl. CPC B01D 65/02; C02F 1/008; C02F 1/44; B01D 61/025; B01D 61/12; B01D 2313/18; B01D 2313/246; B01D 2321/04; B01D 2321/12; C02F 2201/005; C02F 2209/03; C02F 2209/40; C02F 2209/42; C02F 2303/10; C02F 2303/16

(57) ABSTRACT

The present disclosure provides a direct water purification system with an automatic backwash function. The direct water purification system includes a raw water inlet unit, a first pressure valve, a filtration device, a second pressure valve, a purified water outlet unit, a waste water outlet unit, and an energy recovery waterway which is in liquid communication with the filtration device, the second pressure valve and the first pressure valve. The energy recovery waterway is configured to collect purified water and accumulate pressure when the purified water outlet unit is closed, and to back flow the purified water by the accumulated pressure to a filtered water outlet so as to clean a filtration component. The direct water purification system with an automatic backwash function is adapted to automatic clean the direct water purification system each time purified water output is used.

### CROSS-REFERENCE TO RELATED APPLICATION

This non-provisional application claims priority under 35 U.S.C. § 119(a) on Patent Application No. 113144835 filed in Taiwan, R.O.C. on Nov. 21, 2024, the entire contents of which are hereby incorporated by reference.

### BACKGROUND OF THE INVENTION

### 1. Field of the Invention

The present disclosure relates to a direct water purification system, and in particular to a direct water purification system with an automatic backwash function.

### 2. Description of the Related Art

With higher standards of water quality requirements for drinking water, domestic water and industrial water, water purification systems such as water purifiers can filter out various impurities such as sediment, heavy metals, bacteria, residual chlorine in the water from raw water, so as to provide pure, healthy and impurity-free purified water.

The operating principle of water purification systems is, for example, passing raw water through multiple different filter cartridges so as to remove impurities in different sizes and having different physical or chemical properties. Common materials of the filter cartridges for the water purification systems include activated carbon, RO membranes and ultra-filtration membranes, which have different properties.

For example, an RO water purification system is a reverse osmosis water purifier, and the main principle thereof is to intercept harmful substances such as impurities, bacteria and viruses in the water by pressing water molecules through a precise semi-permeable membrane by high pressure and allow pure water molecules to smoothly pass through to the other side of the semi-permeable membrane. The purified water on the other side is then collected to achieve the object of filtering and purifying raw water, and concentrated water (containing impurities, bacteria and viruses which cannot pass through the semi-permeable membrane) on the side of the raw water is discharged through a waste water outlet of the water purification system.

Since an RO water purification system needs to press purified water through a semi-permeable membrane, a water preparation speed is rather slow. A common RO water purification system usually has a large water tank for storing prepared purified water therein, so as to satisfy smooth use of purified water when needed.

In order to overcome the issue of the need of a large water tank of a conventional RO water purification system, a water purification system in a direct form is developed. By improving the water preparation speed of purified water, a water supply amount of purified water sufficient for normal use can be provided in real time. Moreover, the equipment space needed for a water purification system can be saved since a large water tank is no longer required.

However, as described above, in a water purification system using a filter membrane (for example, an RO water purification system intercepting impurities by a semi-permeable membrane), the amount of contaminants residing on a filter membrane thereof increases as time elapses, and this may lead to a problem of rising or instability of total dissolved solids (TDS, indicative of the amount of impurities contained in water) in the purified water prepared, further resulting in issues of degradation of filter quality and impurities getting mixed in the purified water. In addition, along with non-uniform quality of raw water before purification, conditions of a filter membrane cannot be learned during the use of a water purification system and the time for replacement of the filter membrane cannot be easily determined, similarly leading to the problem of instability of TDS.

Therefore, a filtration component such as an RO membrane in a water purification system needs to be cleaned in order to maintain the pureness of the purified water output from the water purification system.

In one known method, stored purified water is used to clean a filtration component by following a same path of raw water. For example, the Taiwan Patent No. I769933 provides an RO pure water preparation system capable of flushing an RO filter membrane by using filtered pure water. In the RO pure water preparation system above, a flush pipeline is disposed in a pure water storage tank collecting pure water and is connected to an initial water inlet pipeline. By guiding pure water previously filtered and stored in the pure water storage tank back to a raw water inlet, clean pure water is used to flow through a same path as the raw water so as to clean the RO filter membrane.

In another known method, stored purified water is pressurized by a pressure pump to cause the purified water to back flow to and clean a filtration component. For example, the Taiwan Patent No. M494025 provides a filtration device capable of backwashing a hollow fiber membrane filtration group by using filtered pure water. In the filtration device, a pressure pump is disposed in a pure water storage tank collecting pure water, and the filtration group is cleaned by pressurizing and flushing pure water previously filtered and stored in the pure water storage tank back to the filtration group.

### BRIEF SUMMARY OF THE INVENTION

The above-mentioned conventional water purification systems capable of cleaning filtration components can be achieved only when predetermined conditions are controlled and met, and the cleaning of the filtration components can only be performed during a predetermined cleaning task or when a predetermined period of time has elapsed, and can only be achieved by involving large-capacity pure water storage tanks.

For example, in the pure water preparation system disclosed by the Taiwan Patent No. I769933, it is necessary to initiatively close the raw water inlet pipeline and initiatively turn on the control for flushing pipelines in a predetermined cleaning process, so that pure water can flush back into the inlet pipeline to perform cleaning. Moreover, guiding such pure water into an originally dirty inlet pipeline for flushing provides a rather limited effect for flushing a filter membrane.

For another example, in a predetermined cleaning process of the filtration device disclosed by the Taiwan Patent No. M494025, it is necessary to initiatively close the raw water inlet, initiatively close the water outlet and initiatively turn on a pressurized pump disposed in the pure water storage tank in order to provide power for pure water to flush back to the filter group to perform cleaning.

To solve the issues above, it is an object of the present disclosure to provide a direct water purification system capable of automatically backwashing a filtration component each time the water purification system outputs purified water, such that cleaning of the filtration component can be performed without needing purified water to flow through a raw water pipeline, without needing all predetermined conditions to be controlled and met, and without involving large-capacity pure water storage tanks.

In view of the above, the present disclosure provides a direct water purification system with an automatic backwash function. With the direct water purification system of the present disclosure, each time a user uses and outputs purified water and then closes the output of the purified water, no predetermined operation or setting has to be performed, and no additional cleaning processes or cleaning conditions have to be arranged, and the water purification system itself is capable of automatically performing the backwash function for a filtration component. Thus, the filtration component can directly obtain cleaning by backwashing from a purified water end to a concentrated water end after each use, and dirt, impurities or bacteria residing on the filtration component can be effectively removed and intercepted, while maintaining TDS stability of the purified water output and the cleanliness of the purified water.

A direct water purification system with an automatic backwash function is provided according to an aspect of the present disclosure. The direct water purification system with an automatic backwash function includes: a raw water inlet unit, configured to receive raw water from an exterior; a first pressure valve, including a first water inlet valve in liquid communication with the raw water inlet unit, a first water outlet valve, a first water inlet, and a first water outlet in liquid communication with the first water inlet, wherein the first pressure valve is configured to disallow flow of liquid between the first water inlet valve and the first water outlet valve when pressure of a liquid flowing through the first water inlet and the first water outlet has reached a first pressure threshold, and to allow flow of liquid between the first water inlet valve and the first water outlet valve when the pressure of the liquid flowing through the first water inlet and the first water outlet does not reach the first pressure threshold; a filtration device, including a filtered water inlet in liquid communication with the first water outlet valve to receive the raw water, a filtration component configured to filter and separate the raw water into purified water and waste water, a filtered water outlet configured to output the purified water obtained from filtering by the filtration component, and a filtered waste water outlet configured to output the waste water separated by the filtration component; a second pressure valve, including a second water inlet valve, a second water outlet valve, a second water inlet in liquid communication with the filtered waste water outlet, and a second water outlet in liquid communication with the second water inlet, wherein the second pressure valve is configured to disallow flow of liquid between the second water inlet valve and the second water outlet valve when the pressure of a liquid flowing through the second water inlet and the second water outlet has reached a second pressure threshold, and to allow flow of liquid between the second water inlet valve and the second water outlet valve when the pressure of the liquid flowing through the second water inlet and the second water outlet does not reach the second pressure threshold; a purified water outlet unit, in liquid communication with the first water outlet, configured to output the purified water to the exterior; a waste water outlet unit, in liquid communication with the second water outlet, configured to output the waste water to the exterior; and an energy recovery waterway, in liquid communication with the filtered water outlet, the second water outlet valve, the second water inlet valve and the first water inlet, wherein the energy recovery waterway is configured to collect the purified water to accumulate pressure when the purified water outlet unit is closed, and to back flow the purified water by the accumulated pressure to the filtered water outlet to clean the filtration component.

In the direct water purification system with an automatic backwash function above, when the purified water outlet unit is closed, the pressure of the liquid flowing through the first water inlet and the first water outlet reaches the first pressure threshold and flow of liquid between the first water inlet valve and the first water outlet valve is disallowed, and the pressure of the liquid flowing through the second water inlet and the second water outlet does not reach the second pressure threshold and flow of liquid between the second water inlet valve and the second water outlet valve is allowed, such that the purified water in the energy recovery waterway back flows to the filtered water outlet and cleans the filtration component.

In the direct water purification system with an automatic backwash function above, when the purified water outlet unit is open, the pressure of the liquid flowing through the first water inlet and the first water outlet does not reach the first pressure threshold and flow of liquid between the first water inlet valve and the first water outlet valve is allowed, and the pressure of the liquid flowing through the second water inlet and the second water outlet reaches the second pressure threshold and flow of liquid between the second water inlet valve and the second water outlet valve is disallowed, such that the purified water output from the filtered water outlet flows forward to the purified water outlet unit.

In the direct water purification system with an automatic backwash function above, the purified water back flowing to the filtered water outlet flows from a purified water region in the filtration device to a raw water region and is discharged via the filtered waste water outlet.

The direct water purification system with an automatic backwash function above further includes: an energy recovery homogenizing device, configured in the energy recovery waterway and adapted to regulate liquid pressure of the purified water; and a first check valve, disposed among the filtered water outlet, the second water outlet valve, the energy recovery homogenizing device and the first water inlet, such that the purified water flows only in a direction away from the filtered water outlet and the second water outlet valve.

The direct water purification system with an automatic backwash function above further includes: a second check valve, disposed among the first check valve, the energy recovery homogenizing device and the first water inlet, such that the purified water flows only in a direction away from the first check valve and the energy recovery homogenizing device.

In the direct water purification system with an automatic backwash function above, when the purified water outlet unit is closed, the liquid pressure of the purified water continuously accumulates in the energy recovery homogenizing device, such that the pressure of the liquid flowing through the first water inlet and the first water outlet reaches the first pressure threshold, and flow of liquid between the first water inlet valve and the first water outlet valve is disallowed; such that the pressure of the liquid flowing through the second water inlet and the second water outlet does not reach the second pressure threshold, and flow of liquid between the second water inlet valve and the second water outlet valve is allowed; and such that the purified water in the energy recovery homogenizing device back flows to the filtered water outlet via the second water inlet valve and the second water outlet valve and cleans the filtration component.

The direct water purification system with an automatic backwash function above further includes: an energy recovery homogenizing device, configured in the energy recovery waterway and adapted to regulate liquid pressure of the purified water; a first check valve, disposed among the filtered water outlet, the second water outlet valve, the energy recovery homogenizing device and the first water inlet, such that the purified water flows only in a direction away from the filtered water outlet and the second water outlet valve; and a third pressure valve, including a third water inlet valve in liquid communication with the energy recovery homogenizing device, a third water outlet valve in liquid communication with the second water inlet valve, a third water inlet in liquid communication with the first water outlet, and a third water outlet in liquid communication with the purified water outlet unit, wherein the third pressure valve is configured to allow flow of liquid between the third water inlet valve and the third water outlet valve when pressure of a liquid flowing through the third water inlet and the third water outlet has reached a third pressure threshold, and to disallow flow of liquid between the third water inlet valve and the third water outlet valve when the pressure of the liquid flowing through the third water inlet and the third water outlet does not reach the third pressure threshold.

The direct water purification system with an automatic backwash function above further includes: a second check valve, disposed among the first check valve, the energy recovery homogenizing device and the first water inlet, such that the purified water flows only in a direction away from the first check valve and the energy recovery homogenizing device.

The direct water purification system with an automatic backwash function above further includes: a pressure reducing valve, disposed between the first water outlet and the third water inlet, configured to have liquid pressure at an end of the third water inlet be less than that at an end of the first water outlet; and a third check valve, disposed between the third water outlet and the purified water outlet unit, for the purified water to flow only in a direction away from the third water outlet.

In the direct water purification system with an automatic backwash function above, when the purified water outlet unit is closed, the liquid pressure of the purified water continuously accumulates in the energy recovery homogenizing device, such that the pressure of the liquid flowing through the first water inlet and the first water outlet reaches the first pressure threshold, and flow of liquid between the first water inlet valve and the first water outlet valve is disallowed; such that the pressure of the liquid flowing through the second water inlet and the second water outlet does not reach the second pressure threshold, and flow of liquid between the second water inlet valve and the second water outlet valve is allowed; such that the pressure of the liquid flowing through the third water inlet and the third water outlet reaches the third pressure threshold, and flow of liquid between the third water inlet valve and the third water outlet valve is allowed; and such that the purified water in the energy recovery homogenizing device back flows to the filtered water outlet via the third water inlet valve, the third water outlet valve, the second water inlet valve and the second water outlet valve and cleans the filtration component.

The direct water purification system with an automatic backwash function above further includes: an energy recovery homogenizing device, configured in the energy recovery waterway and adapted to regulate liquid pressure of the purified water; a first check valve, disposed among the filtered water outlet, the second water outlet valve, the energy recovery homogenizing device and the first water inlet, such that the purified water flows only in a direction away from the filtered water outlet and the second water outlet valve; a pressure sensor, configured to sense liquid pressure of the energy recovery homogenizing device and/or an adjacent waterway; and an electromagnetic valve, disposed between the energy recovery homogenizing device and the second water inlet valve, configured to allow flow of liquid through the electromagnetic valve when the liquid pressure sensed by the pressure sensor has reached a fourth pressure threshold, and to disallow flow of liquid through the electromagnetic valve when the liquid pressure sensed by the pressure sensor does not reach the fourth pressure threshold.

The direct water purification system with an automatic backwash function above further includes: a second check valve, disposed among the first check valve, the energy recovery homogenizing device and the first water inlet, such that the purified water flows only in a direction away from the first check valve and the energy recovery homogenizing device.

In the direct water purification system with an automatic backwash function above, when the purified water outlet unit is closed, the liquid pressure of the purified water continuously accumulates in the energy recovery homogenizing device, such that the pressure of the liquid flowing through the first water inlet and the first water outlet reaches the first pressure threshold, and flow of liquid between the first water inlet valve and the first water outlet valve is disallowed; such that the pressure of the liquid flowing through the second water inlet and the second water outlet does not reach the second pressure threshold, and flow of liquid between the second water inlet valve and the second water outlet valve is allowed; and the liquid pressure of the energy recovery homogenizing device sensed by the pressure sensor reaches the fourth pressure threshold, such that flow of liquid through the electromagnetic valve is allowed, and the purified water in the energy recovery homogenizing device back flows to the filtered water outlet via the electromagnetic valve, the second water inlet valve and the second water outlet valve and cleans the filtration component.

A direct water purification system with an automatic backwash function is further provided according to another aspect of the present disclosure. The direct water purification system with an automatic backwash function includes: a raw water inlet unit, configured to receive raw water from an exterior; a first control valve, including a first water inlet valve in liquid communication with the raw water inlet, a first water outlet valve, a first water inlet, and a first water outlet in liquid communication with the first water inlet; a filtration device, including a filtered water inlet in liquid communication with the first water outlet valve to receive the raw water, a filtration component configured to filter and separate the raw water into purified water and waste water, a filtered water outlet configured to output the purified water obtained from filtering by the filtration component, and a filtered waste water outlet configured to output waste water separated by the filtration component; a second control valve, including a second water inlet valve, a second water outlet valve, a second water inlet in liquid communication with the filtered waste water outlet, and a second water outlet in liquid communication with the second water inlet; a purified water outlet unit, in liquid communication with the first water outlet, configured to output the purified water to the exterior; a waste water outlet unit, in liquid communication with the second water outlet, configured to output the waste water to the exterior; an energy recovery waterway, in liquid communication with the filtered water outlet, the second water outlet valve, the second water inlet valve and the first water inlet; an energy recovery homogenizing device, configured in the energy recovery waterway and adapted to regulate liquid pressure of the purified water; a flow sensor, configured to sense flow of a liquid output to the purified water outlet unit; and a controller, electrically connected to the energy recovery homogenizing device and the flow sensor, configured to have the energy recovery homogenizing device output the purified water when the flow sensor detects that the flow of the liquid is decreased.

In the direct water purification system with an automatic backwash function above, the first control valve and the second control valve are electrically connected to the controller, and are configured to control flow of liquid between the first water inlet valve and the first water outlet valve of the first control valve, and to control flow of liquid between the second water inlet valve and the second water outlet valve of the second control valve.

The direct water purification system with an automatic backwash function above further includes: a first check valve, disposed among the filtered water outlet, the second water outlet valve, the energy recovery homogenizing device and the first water inlet, such that the purified water flows only in a direction away from the filtered water outlet and the second water outlet valve; a second check valve, disposed among the first check valve, the energy recovery homogenizing device and the first water inlet, such that the purified water flows only in a direction away from the first check valve and the energy recovery homogenizing device; and a fourth check valve, disposed between the energy recovery homogenizing device and the second water inlet valve, such that the purified water flows only in a direction away from the energy recovery homogenizing device.

In the direct water purification system with an automatic backwash function above, the first control valve is configured to disallow flow of liquid between the first water inlet valve and the first water outlet valve when pressure of a liquid flowing through the first water inlet and the first water outlet has reached a first pressure threshold, and to allow flow of liquid between the first water inlet valve and the first water outlet valve when the pressure of the liquid flowing through the first water inlet and the first water outlet does not reach the first pressure threshold; and the second control valve is configured to disallow flow of liquid between the second water inlet valve and the second water outlet valve when pressure of a liquid flowing through the second water inlet and the second water outlet has reached a second pressure threshold, and to allow flow of liquid between the second water inlet valve and the second water outlet valve when the pressure of the liquid flowing through the second water inlet and the second water outlet does not reach the second pressure threshold.

In the direct water purification system with an automatic backwash function above, the energy recovery homogenizing device further includes: a cavity; a valve, disposed in the cavity, operable to enable the cavity to selectively be in liquid communication with a waterway connected to the energy recovery homogenizing device; a flow sensor, disposed at the valve, configured to sense flow of a liquid flowing through the valve; a water level sensor, disposed in the cavity, configured to sense a water level of a liquid within the cavity; a partition board, disposed in the cavity, configured to be movable to change volume of the cavity; and a shifter, disposed in the cavity, configured to be controlled by the controller to adjust a position of the partition board.

In the direct water purification system with an automatic backwash function of the present disclosure, the first pressure valve controlling flow of liquid by liquid pressure or flow is disposed at the raw water inlet unit and the purified water outlet unit, the second pressure valve controlling flow of liquid by liquid pressure or flow is disposed at the filtered water outlet and the filtered waste water outlet, and the energy recovery waterway capable of accumulating liquid pressure is in liquid communication with the first pressure valve, the second pressure valve and the filtration device. Thus, the pressure change in the waterway of the purified water outlet unit can be regulated by means of opening and closing of the purified water outlet unit, so as to automatically disconnect flow of liquid of part of waterways of the first pressure valve and the second pressure valve, respectively, thereby achieving the effect of backwashing the filtration component by automatically flushing purified water back to the filtration device and flushing the purified water from the purified water region to the raw water region. Therefore, with the design of waterways of the direct water purification system with an automatic backwash function of the present disclosure, each time the water purification system outputs purified water, that is, each time the purified water outlet unit is closed, backwash for the filtration component can be automatically performed. Thus, without needing a user or other setting for initiatively controlling opening and closing of various valves or components in order to perform cleaning of the filtration component, and without involving large-capacity pure water storage tanks or any flow through a raw water pipeline, the filtration component can be cleaned by automatic back flush from the purified water end to the concentrated water end after each use, thereby effectively removing and intercepting dirt, impurities or bacteria residing on the filtration component, achieving effects of maintaining the TDS stability of purified water output and cleanliness of the purified water for an extended period of time, and reducing consumption of the filtration component.

### BRIEF DESCRIPTION OF THE DRAWINGS

FIG. 1 is a schematic diagram of configuration of a direct water purification system with an automatic backwash function according to a first embodiment of the present disclosure.

FIG. 1A is a schematic diagram of configuration of a direct water purification system with an automatic backwash function in a water purifying state according to the first embodiment of the present disclosure.

FIG. 1B is a schematic diagram of configuration of a direct water purification system with an automatic backwash function in a backwash state according to the first embodiment of the present disclosure.

FIG. 2 is a schematic diagram of configuration of a direct water purification system with an automatic backwash function according to a second embodiment of the present disclosure.

FIG. 2A is a schematic diagram of configuration of a direct water purification system with an automatic backwash function in a water purifying state according to the second embodiment of the present disclosure.

FIG. 2B is a schematic diagram of configuration of a direct water purification system with an automatic backwash function in a backwash state according to the second embodiment of the present disclosure.

FIG. 3 is a schematic diagram of configuration of a direct water purification system with an automatic backwash function according to a third embodiment of the present disclosure.

FIG. 3A is a schematic diagram of configuration of a direct water purification system with an automatic backwash function in a water purifying state according to the third embodiment of the present disclosure.

FIG. 3B is a schematic diagram of configuration of a direct water purification system with an automatic backwash function in a backwash state according to the third embodiment of the present disclosure.

FIG. 4 is a schematic diagram of configuration of a direct water purification system with an automatic backwash function according to a fourth embodiment of the present disclosure.

FIG. 4A is a schematic diagram of configuration of a direct water purification system with an automatic backwash function in a water purifying state according to the fourth embodiment of the present disclosure.

FIG. 4B is a schematic diagram of configuration of a direct water purification system with an automatic backwash function in a backwash state according to the fourth embodiment of the present disclosure.

FIG. 5 is a schematic diagram of configuration of a direct water purification system with an automatic backwash function according to a fifth embodiment of the present disclosure.

FIG. 5A is a schematic diagram of configuration of a direct water purification system with an automatic backwash function in a water purifying state according to the fifth embodiment of the present disclosure.

FIG. 5B is a schematic diagram of configuration of a direct water purification system with an automatic backwash function in a backwash state according to the fifth embodiment of the present disclosure.

FIG. 6 is a schematic diagram of configuration of an energy recovery homogenizing device of a direct water purification system with an automatic backwash function according to an embodiment of the present disclosure.

FIG. 7A is a schematic diagram of configuration of flow of liquid allowed on both sides of pressure valves of a direct water purification system with an automatic backwash function according to an embodiment of the present disclosure.

FIG. 7B is a schematic diagram of configuration of flow of liquid disallowed on one side of pressure valves of a direct water purification system with an automatic backwash function according to an embodiment of the present disclosure.

### DETAILED DESCRIPTION OF THE INVENTION

The technical features of the present disclosure are further described in detail by way of embodiments with the accompanying drawings below. It should be noted that, in the present disclosure, terms such as “first”, “second” and “third” are used to distinguish differences among elements, and are not to be construed as limiting to the elements themselves or specific orders of the elements. Moreover, in the present disclosure, when a specific quantity is not specified, the article “a/an” refers to one element or more than one element.

To facilitate understanding of the object, characteristics and effects of the present disclosure, embodiments together with the attached drawings for the detailed description of the present disclosure are provided below.

The present disclosure provides a direct water purification system with an automatic backwash function. With the direct water purification system of the present disclosure, each time a user finishes using and outputting purified water and then closes the output of the purified water, for example, closing a tap that outputs the purified water, the water purification system itself is capable of automatically performing the backwash function for the filtration component. Thus, the filtration component can be directly cleaned by back flushing from a purified water end to a concentrated water end after each use, and dirt, impurities or bacteria residing on the filtration component can be effectively removed and intercepted, while maintaining TDS stability of the purified water output and the cleanliness of the purified water, without needing any predetermined cleaning operations or cleaning settings and without needing to arrange a schedule for additional cleaning procedures or needing a user to initiatively open or close certain valves so as to achieve cleaning conditions.

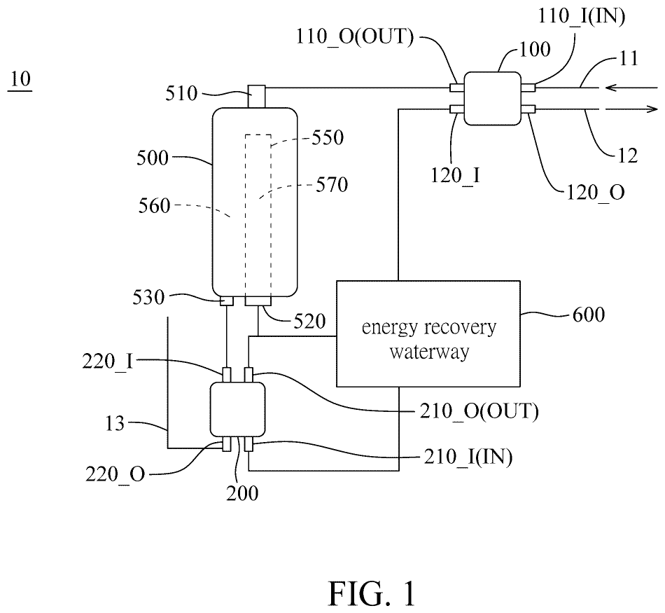

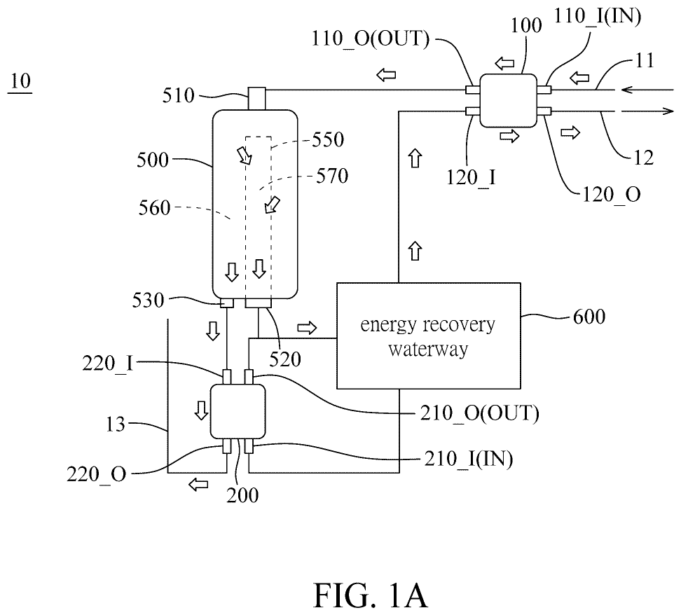

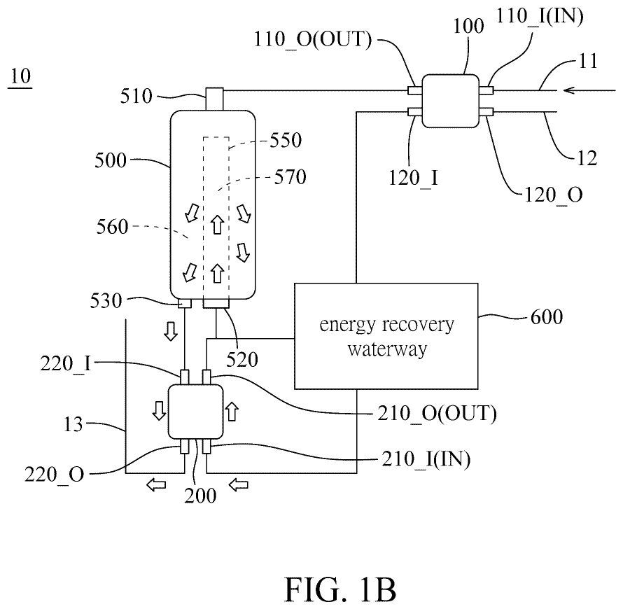

FIG. 1 shows a schematic diagram of configuration of a direct water purification system with an automatic backwash function according to a first embodiment of the present disclosure. FIG. 1A shows a schematic diagram of configuration of a direct water purification system with an automatic backwash function in a water purifying state according to the first embodiment of the present disclosure. FIG. 1B shows a schematic diagram of configuration of a direct water purification system with an automatic backwash function in a backwash state according to the first embodiment of the present disclosure.

Referring to FIG. 1, a direct water purification system 10 with an automatic backwash function is disclosed in an embodiment of the present disclosure. The direct water purification system 10 with an automatic backwash function includes a raw water inlet unit 11, a first pressure valve 100, a filtration device 500, a second pressure valve 200, a purified water outlet unit 12, a waste water outlet unit 13, and an energy recovery waterway 600.

The raw water inlet unit 11 is configured to receive raw water from an exterior, for example, the arrow shown on the right of the raw water inlet unit 11 in FIG. 1 shows an input of raw water. In one embodiment, raw water refers to an input of raw water entering the direct water purification system 10 with an automatic backwash function, and may be from various water sources such as tap water, well water, underground water, bottled water, a rain water collection device, lake water or sea water. Any water or liquid input into and to undergo filtration and purification by the direct water purification system 10 with an automatic backwash function is referred to as “raw water” herein.

The first pressure valve 100 includes a first water inlet valve 110_I(IN), a first water outlet valve 110_O(OUT), a first water inlet 120_I and a first water outlet 120_O. The first water inlet valve 110_I(IN) and the first water outlet valve 110_O(OUT) are in liquid communication with each other in the first pressure valve 100, but may be converted to be not in liquid communication with each other by means of such as liquid pressure or signal control, with related details to be described in the present disclosure below. The first water inlet 120_I and the first water outlet 120_O are in liquid communication with each other in the first pressure valve 100. The first water inlet valve 110_I(IN) is in liquid communication with the raw water inlet unit 11 so as to receive inflow of the raw water.

In one embodiment, the first pressure valve 100 is configured to disallow flow of liquid between the first water inlet valve 110_I(IN) and the first water outlet valve 110_O(OUT) when pressure of a liquid flowing through the first water inlet 120_I and the first water outlet 120_O has reached a first pressure threshold, and to allow flow of liquid between the first water inlet valve 110_I(IN) and the first water outlet valve 110_O(OUT) when the pressure of the liquid flowing through the first water inlet 120_I and the first water outlet 120_O does not reach the first pressure threshold. In other words, the first pressure valve 100 may determine whether to allow liquid communication between the first water inlet valve 110_I(IN) and the first water outlet valve 110_O(OUT) according to the pressure of the liquid flowing through the first water inlet 120_I and the first water outlet 120_O. In one embodiment, the first pressure valve 100 may be a four-sided valve. In one embodiment, the first pressure threshold according to which the first pressure valve 100 determines whether to allow liquid communication between the first water inlet valve 110_I(IN) and the first water outlet valve 110_O(OUT) may vary according to such as scenarios of use, pipeline configurations, pressure of an input of raw water and pressure of an output of purified water, and is for example, within a range between 20 psi and 60 psi; however, this range is merely an example of a common scenario and is not limited thereto. All means that regulate according to pressure of a liquid at one end of a pressure valve whether to allow communication of a liquid at the other end are encompassed within the scope of the pressure valve described in the present disclosure. Moreover, the denotations (IN) and (OUT) represent ends that are subject to influences of the pressure of a liquid and hence allowed to flow or close.

The filtration device 500 includes a filtered water inlet 510, a filtered water outlet 520, a filtered waste water outlet 530, a filtration component 550, a raw water region 560 and a purified water region 570. The filtered water inlet 510 is in liquid communication with the first water outlet valve 110_O(OUT) to receive the raw water. The filtration component 550 is configured to filter and separate the raw water into purified water and waste water (also sometimes referred to as concentrated water containing impurities). The filtered water outlet 520 is configured to output the purified water obtained from filtering by the filtration component 550. The filtered waste water outlet 530 is configured to output waste water separated by the filtration component 550. In one embodiment, as shown in FIG. 1, the purified water obtained from filtering is located in the purified water region 570 inside the filtration component 550, and unfiltered raw water and the residual waste water are located in the raw water region 560 outside the filtration component 550. However, the distribution of inside, outside and specific spaces is not limited to the example above, and all elements capable of separating raw water into purified water and waste water by using the filtration component 550 are encompassed within the scope of the filtration device 500 described in the present disclosure.

The second pressure valve 200 includes a second water inlet valve 210_I(IN), a second water outlet valve 210_O(OUT), a second water inlet 220_I and a second water outlet 220_O. The second water inlet valve 210_I(IN) and the second water outlet valve 210_O(OUT) are in liquid communication with each other in the second pressure valve 200, but may be converted to be not in liquid communication with each other by means of such as liquid pressure or signal control. The second water inlet 220_I and the second water outlet 220_O are in liquid communication with each other in the second pressure valve 200. The second water inlet 220_I is in liquid communication with the filtered waste water outlet 530.

In one embodiment, the second pressure valve 200 is configured to disallow flow of liquid between the second water inlet valve 210_I(IN) and the second water outlet valve 210_O(OUT) when pressure of a liquid flowing through the second water inlet 220_I and the second water outlet 220_O has reached a second pressure threshold, and to allow flow of liquid between the second water inlet valve 210_I(IN) and the second water outlet valve 210_O(OUT) when the pressure of the liquid flowing through the second water inlet 220_I and the second water outlet 220_O does not reach the second pressure threshold. In other words, the second pressure valve 200, having the same principle as the first pressure valve 100, may determine whether to allow liquid communication between the second water inlet valve 210_I(IN) and the second water outlet valve 210_O(OUT) according to the pressure of the liquid flowing through the second water inlet 220_I and the second water outlet 220_O. In one embodiment, the second pressure valve 200 may be a four-sided valve. In one embodiment, the second pressure threshold according to which the second pressure valve 200 determines whether to allow liquid communication between the second water inlet valve 210_I(IN) and the second water outlet valve 210_O(OUT) may vary according to such as scenarios of use, pipeline configurations, pressure of an input of raw water and pressure of an output of purified water, and is for example, within a range between 20 psi and 60 psi; however, this range is merely an example of a common scenario and is not limited thereto. All means that regulate according to pressure of a liquid at one end of a pressure valve whether to allow communication of a liquid at the other end are encompassed within the scope of the pressure valve described in the present disclosure.

The purified water outlet unit 12 is in liquid communication with the first water outlet 120_O, and is configured to output the purified water to an exterior, for example, outputting the purified water to a purified water tap of a water purification system.

The waste water outlet unit 13 is in liquid communication with the second water outlet 220_O, and is configured to output the waste water to the exterior, for example, discharging the waste water to a discharge pipeline of a water purification system, or the waste water may be further processed by other devices, or the waste water may be stored by other liquid storage apparatuses.

The energy recovery waterway 600 is in liquid communication with the filtered water outlet 520, the second water outlet valve 210_O(OUT), the second water inlet valve 210_I(IN) and the first water inlet 120_I. The energy recovery waterway 600 is configured to collect purified water and accumulate pressure when the purified water outlet unit 12 is closed, and to back flow the purified water by the accumulated pressure to the filtered water outlet 520 so as to clean the filtration component 550.

Referring to FIG. 1A, FIG. 1A shows a schematic diagram of configuration of the direct water purification system 10 with an automatic backwash function in a water purifying state. In the water purifying state, the purified water outlet unit 12 is open, and raw water continuously flows in from the raw water inlet unit 11. At this point in time, the raw water flows through the first water inlet 120_I and the first water outlet 120_O communicated by the first pressure valve 100, and flows to the filtration device 500. After the filtration device 500 filters and separates raw water into purified water and waste water, due to a greater pressure at the waste water end, when the waste water flows through the second water inlet 220_I and the second water outlet 220_O communicated by the second pressure valve 200, the waste water flowing through the second water inlet 220_I and the second water outlet 220_O in the water purifying state is greater than the second pressure threshold. At this point in time, the second water inlet valve 210_I(IN) and the second water outlet valve 210_O(OUT) of the second pressure valve 200 are in a state of disallowing flow of liquid in between. The purified water flowing out from the filtered water outlet 520 continues flowing to and fills the inside of the energy recovery waterway 600, and the purified water is continuously output to the first water inlet 120_I and the first water outlet 120_O of the first pressure valve 100 and output to the purified water outlet unit 12 to reach the exterior of the direct water purification system 10 with an automatic backwash function. In one embodiment, the inside of the energy recovery waterway 600 may also be filled with purified water during system setup, for example, having purified water stored therein in advance during apparatus installation by a supplier for a client, so as to maintain the internal pressure thereof.

Referring to FIG. 1B, FIG. 1B shows a schematic diagram of configuration of the direct water purification system 10 with an automatic backwash function in a backwash state according to the first embodiment of the present disclosure. When the purified water outlet unit 12 is closed, for example, when a tap of a water purification system is closed by a user, the purified water outlet unit 12 is no longer able to output purified water. At this point in time, raw water received from the raw water inlet unit 11 continues flowing in, the filtration device 500 continues preparing water, and the prepared water continues flowing into the energy recovery waterway 600. Along with overall pressure balance, due to the liquid pressure at the first water inlet 120_I and the first water outlet 120_O of the first pressure valve 100, the first pressure valve 100 is caused to operate such that the first water inlet valve 110_I(IN) and the first water outlet valve 110_O(OUT) change to a state of disallowing flow of liquid in between, hence closing the input of raw water. Then, due to the disconnection of the input of raw water, the filtration device 500 stops preparing water, such that the liquid pressure of the filtered waste water flowing through the second water inlet 220_I and the second water outlet 220_O of the second pressure valve 200 is reduced. At this point in time, the waste water flowing through the second water inlet 220_I and the second water outlet 220_O in the backwash state is less than the second pressure threshold, and so the second water inlet valve 210_I(IN) and the second water outlet valve 210_O(OUT) of the second pressure valve 200 change to a state of allowing flow of liquid in between. Thus, the pressure originally accumulated in the energy recovery waterway 600 due to pressure of closing of the purified water outlet unit 12 back flushes via the second water inlet valve 210_I(IN) and the second water outlet valve 210_O(OUT) of the second pressure valve 200 to the filtered water outlet 520 of the filtration device 500. At this point in time, the input of raw water is closed because flow of liquid between the first water inlet valve 110_I(IN) and the first water outlet valve 110_O(OUT) is disallowed, the purified water back flushing to the filtered water outlet 520 of the filtration device 500 back flushes from the purified water region 570 to the raw water region 560 to achieve an effect of backwashing the filtration component 550 and effectively performs cleaning from a clean region to a dirty region. Thus, dirt, impurities or bacteria intercepted at the filtration component 550 (for example, an RO membrane, or various filter membranes, filter nets or absorbing materials) can be flushed to the raw water region 560 and be discharged via the filtered waste water outlet 530, thereby automatically achieving the function of automatic backwash due to pressure changes of a liquid immediately after the purified water outlet unit 12 is closed. When purified water is needed again, only the purified water outlet unit 12 needs to be opened to release the liquid pressure at the first water inlet 120_I and the first water outlet 120_O of the first pressure valve 100, and the communication between the first water inlet valve 110_I(IN) and the first water outlet valve 110_O(OUT) is again allowed, such that water can then be prepared normally.

Thus, each time a water purification system outputs purified water, backwash for a filtration component can be automatically performed, without needing other operations or settings of a user, without any additional pump or power input for powering backwashing, without involving large-capacity purified water storage tanks and without flowing through a raw water pipeline that may again bring contaminants to a filtration device. With the liquid pressure of purified water quickly accumulated during a time difference between preparing of purified water in the water purifying state and closing of the output of purified water, the switch of backwash can be automatically turned on by the liquid pressure of the purified water accumulated during the time difference. Thus, the filtration component, each time it is used, can be automatically cleaned by back flushing from the purified water end to the concentrated water end, and contaminants filtered out on the filtration component can be effectively removed, hence achieving effects of maintaining the TDS stability of purified water output and cleanliness of purified water for an extended period of time.

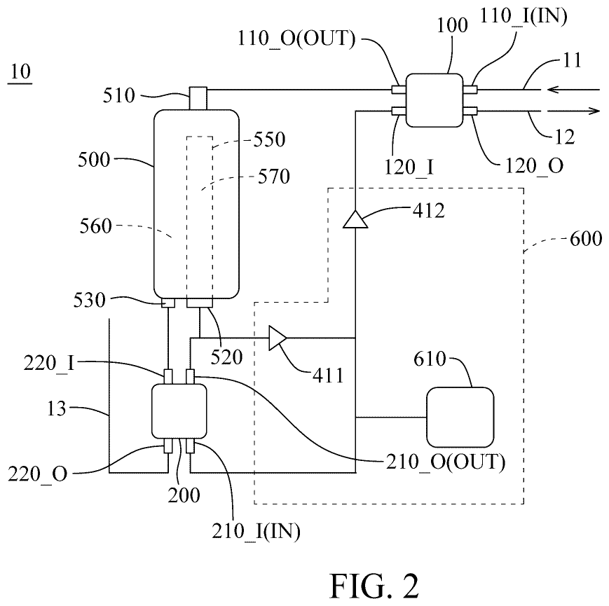

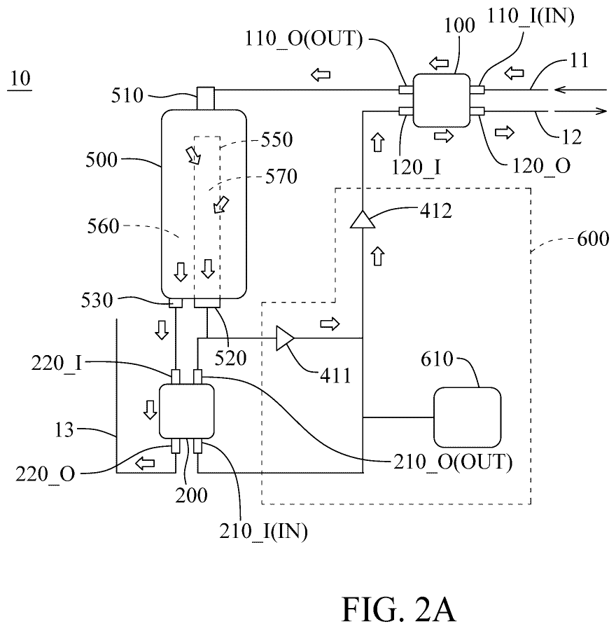

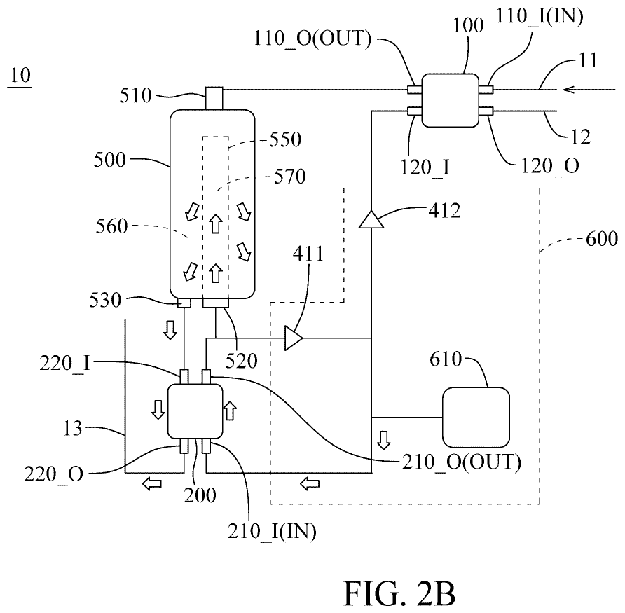

FIG. 2 shows a schematic diagram of configuration of a direct water purification system with an automatic backwash function according to a second embodiment of the present disclosure. FIG. 2A shows a schematic diagram of configuration of a direct water purification system with an automatic backwash function in a water purifying state according to the second embodiment of the present disclosure. FIG. 2B shows a schematic diagram of configuration of a direct water purification system with an automatic backwash function in a backwash state according to the second embodiment of the present disclosure.

Referring to FIG. 2, FIG. 2A and FIG. 2B, in one embodiment, the direct water purification system 10 with an automatic backwash function further includes an energy recovery homogenizing device 610 configured in the energy recovery waterway 600 and adapted to regulate liquid pressure of the purified water. In one embodiment, the energy recovery homogenizing device 610 is a liquid storage tank. In one embodiment, the direct water purification system 10 with an automatic backwash function further includes a first check valve 411. The first check valve 411 is disposed among the filtered water outlet 520, the second water outlet valve 210_O, the energy recovery homogenizing device 610 and the first water inlet 120_I, such that the purified water is allowed to flow only in a direction away from the filtered water outlet 520 and the second water outlet valve 210_O. As shown in FIG. 2A, the purified water prepared during water preparation in the water purifying state can only flow into the energy recovery waterway 600 and be output at the purified water outlet unit 12. Moreover, since flow of liquid between the second water inlet valve 210_I(IN) and the second water outlet valve 210_O(OUT) is disallowed and the first check valve 411 back stops, the liquid pressure of the purified water can be better accumulated in the energy recovery waterway 600 and/or at the energy recovery homogenizing device 610.

In one embodiment, the direct water purification system 10 with an automatic backwash function above further includes a second check valve 412. The second check valve 412 is disposed among the first check valve 411, the energy recovery homogenizing device 610 and the first water inlet 120_I, such that purified water flows only in a direction away from the first check valve 411 and the energy recovery homogenizing device 610. Accordingly, as shown in FIG. 2B, the purified water having a higher liquid pressure stored at the energy recovery waterway 600 and/or in the energy recovery homogenizing device 610 flows only in a direction toward the second pressure valve 200. Moreover, with the second check valve 412 provided, the liquid pressure at the first water inlet 120_I and the first water outlet 120_O of the first pressure valve 100 is not reduced during a period of backwash, so that the energy recovery waterway 600 can output more purified water to back wash the filtration device 500, and that flow of liquid between the first water inlet valve 110_I(IN) and the first water outlet valve 110_O(OUT) is not restored and raw water is input to start water preparation too quickly.

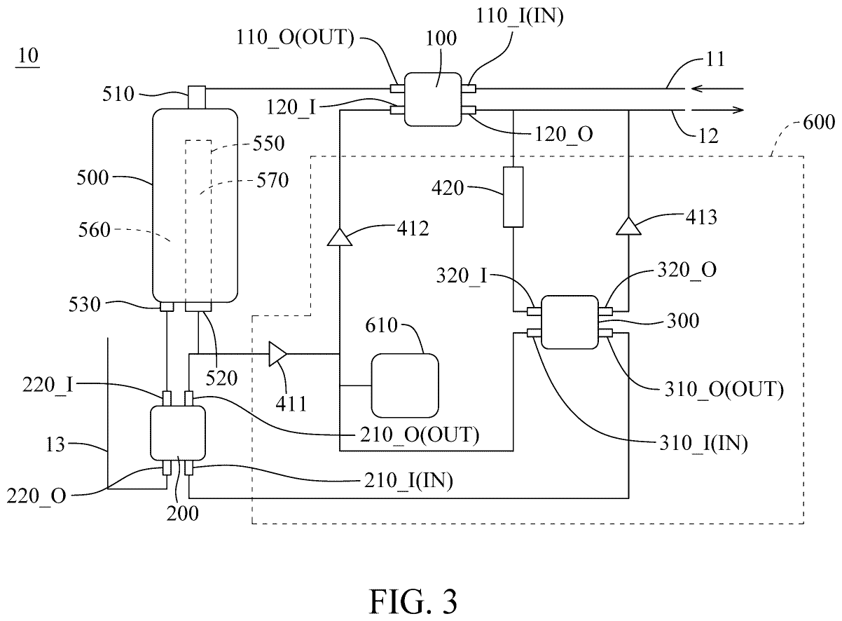

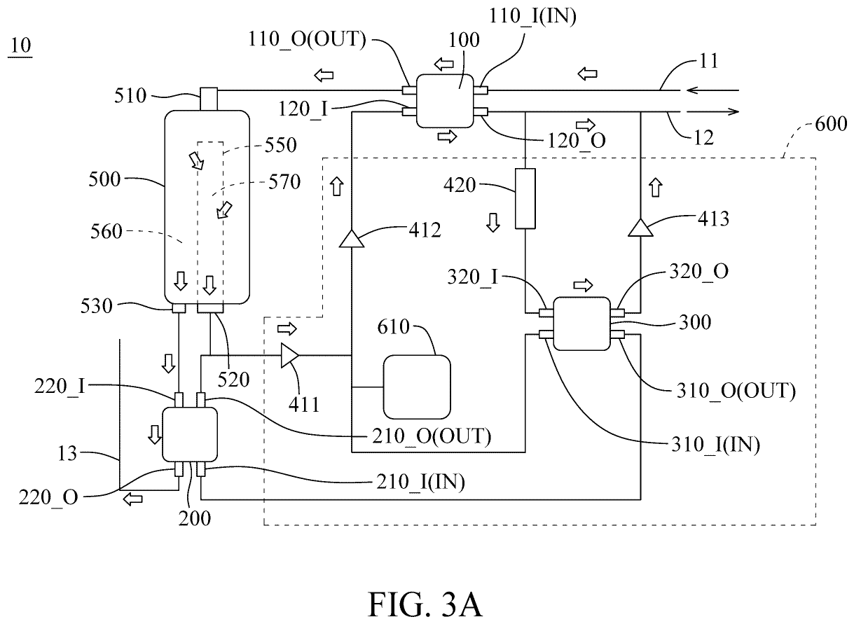

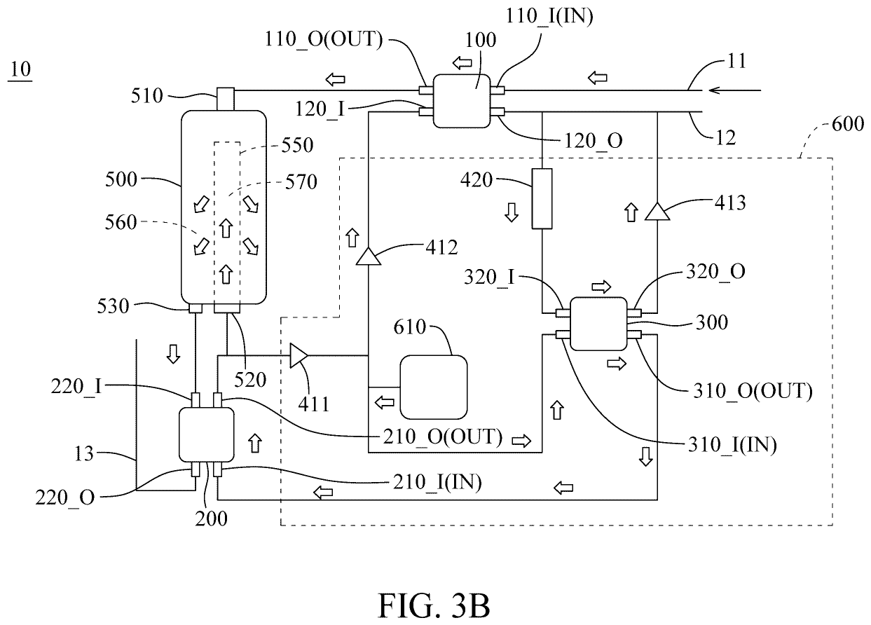

FIG. 3 shows a schematic diagram of configuration of a direct water purification system with an automatic backwash function according to a third embodiment of the present disclosure. FIG. 3A shows a schematic diagram of configuration of a direct water purification system with an automatic backwash function in a water purifying state according to the third embodiment of the present disclosure. FIG. 3B shows a schematic diagram of configuration of a direct water purification system with an automatic backwash function in a backwash state according to the third embodiment of the present disclosure.

Referring to FIG. 3, FIG. 3A and FIG. 3B, in one embodiment, the direct water purification system 10 with an automatic backwash function further includes an energy recovery homogenizing device 610 configured in the energy recovery waterway 600 and adapted to regulate liquid pressure of the purified water. In one embodiment, the direct water purification system 10 with an automatic backwash function further includes a first check valve 411. The first check valve 411 is disposed among the filtered water outlet 520, the second water outlet valve 210_O, the energy recovery homogenizing device 610 and the first water inlet 120_I, such that the purified water is allowed to flow only in a direction away from the filtered water outlet 520 and the second water outlet valve 210_O. As shown in FIG. 3A, the purified water prepared during water preparation in the water purifying state can only flow into the energy recovery waterway 600 and be output at the purified water outlet unit 12. Moreover, since flow of liquid between the second water inlet valve 210_I(IN) and the second water outlet valve 210_O(OUT) is disallowed and the first check valve 411 back stops, the liquid pressure of the purified water can be better accumulated in the energy recovery waterway 600 and/or at the energy recovery homogenizing device 610.

Referring to FIG. 3, in one embodiment, the direct water purification system 10 with an automatic backwash function further includes a third pressure valve 300, which functions in a manner substantially identical to those of the first pressure valve 100 and the second pressure valve 200. However, it should be noted that, the first pressure valve 100 and the second pressure valve 200 above are configured to disallow flow of liquid on one side thereof when the pressure on one other side thereof has reached a predetermined threshold, whereas the third pressure valve 300 is configured to allow flow of liquid on one side thereof when the pressure on one other side thereof has reached a predetermined threshold.

The third pressure valve 300 includes a third water inlet valve 310_I(IN), a third water outlet valve 310_O(OUT), a third water inlet 320_I and a third water outlet 320_O. The third water inlet valve 310_I(IN) is in liquid communication with the energy recovery homogenizing device 610. The third water outlet valve 310_O(OUT) is in liquid communication with the second water inlet valve 210_I(IN). The third water inlet 320_I is in liquid communication with the first water outlet 120_O. The third water outlet 320_O is in liquid communication with the purified water outlet unit 12. The third pressure valve 300 is configured to allow flow of liquid between the third water inlet valve 310_I(IN) and the third water outlet valve 310_O(OUT) when pressure of a liquid flowing through the third water inlet 320_I and the third water outlet 320_O has reached a third pressure threshold, and to disallow flow of liquid between the third water inlet valve 310_I(IN) and the third water outlet valve 310_O(OUT) when the pressure of the liquid flowing through the third water inlet 320_I and the third water outlet 320_O does not reach the third pressure threshold. In one embodiment, the third pressure threshold associated with the third pressure valve 300 similarly varies according to such as scenarios of use, pipeline configurations, pressure of an input of raw water and pressure of an output of purified water.

In one embodiment, as shown in FIG. 3B, the direct water purification system 10 with an automatic backwash function above further includes a second check valve 412. The second check valve 412 is disposed among the first check valve 411, the energy recovery homogenizing device 610 and the first water inlet 120_I, such that the purified water flows only in a direction away from the first check valve 411 and the energy recovery homogenizing device 610. Accordingly, as shown in FIG. 3B, the purified water having a higher liquid pressure stored at the energy recovery waterway 600 and/or in the energy recovery homogenizing device 610 flows only in a direction toward the second pressure valve 200. Moreover, with the second check valve 412 provided, the liquid pressure at the first water inlet 120_I and the first water outlet 120_O of the first pressure valve 100 is not reduced during a period of backwash, so that the energy recovery waterway 600 can output more purified water to back wash the filtration device 500, and that flow of liquid between the first water inlet valve 110_I(IN) and the first water outlet valve 110_O(OUT) is not restored and raw water is input to start water preparation too quickly.

In one embodiment, as shown in FIG. 3B, the direct water purification system 10 with an automatic backwash function further includes a pressure reducing valve 420 and a third check valve 413. The pressure reducing valve 420 is disposed between the first water outlet 120_O and the third water inlet 320_I, and is configured to have the liquid pressure at the end of the third water inlet 320_I be less than that at the end of the first water outlet 120_O. In one embodiment, the pressure reducing valve 420 is configured to reduce the liquid pressure by 15 psi. It should be noted that, the magnitude of pressure reduction performed by the pressure reducing valve 420 may similarly vary according to such as required scenarios of use, pipeline configurations, pressure of an input of raw water and pressure of an output of purified water, as well as the third pressure threshold of the third pressure valve 300. The third check valve 413 is disposed between the third water outlet 320_O and the purified water outlet unit 12, such that purified water flows only in a direction away from the third water outlet 320_O.

With the pressure reducing valve 420 and the third check valve 413 provided, unexpected liquid communication between the third water inlet valve 310_I(IN) and the third water outlet valve 310_O(OUT) of the third pressure valve 300 in the water purifying state can be prevented. In addition, in the backwash state, the liquid pressure at the third water inlet 320_I and the third water outlet 320_O of the third pressure valve 300 can also be maintained, so as to continuously open the third water inlet valve 310_I(IN) and the third water outlet valve 310_O(OUT) of the third pressure valve 300 and allow flow of liquid, and continuously output the purified water from the energy recovery waterway 600 and/or the energy recovery homogenizing device 610 to back wash the filtration device 500 until the liquid pressure thereof is balanced, hence providing a longer backwash time and a greater amount of purified water for backwash. In one embodiment, the energy recovery waterway 600 and/or the energy recovery homogenizing device 610 can continue outputting purified water until about one half of the amount of purified water remains in the energy recovery waterway 600 and/or the energy recovery homogenizing device 610. In one embodiment, the purified water accumulated the energy recovery waterway 600 and/or the energy recovery homogenizing device 610 can also provide an effect of maintaining a stable amount of purified water in the water purifying state. With the waterway configuration in FIG. 3, the direct water purification system 10 with an automatic backwash function is similarly capable of providing backwash power without needing any means of external power such as additional electrical power, additional liquid pressurization or pumps. The direct water purification system 10 with an automatic backwash function disclosed by the present application is capable of naturally accumulating the liquid pressure of purified water in the water purifying state according to the waterway configuration thereof, quickly accumulating the liquid pressure in various parts of the waterway by using the time difference of closing the output of purified water and the configuration of various sections in the waterway, and opening different pressure valves by using the accumulated liquid pressure in the sections, so as to respectively achieve closing a waterway for an input of raw water and opening a backwash waterway. Moreover, without needing any additional power, the filtration device 500 can be automatically back washed for a period of time after each use, and water preparation can also be re-started any time.

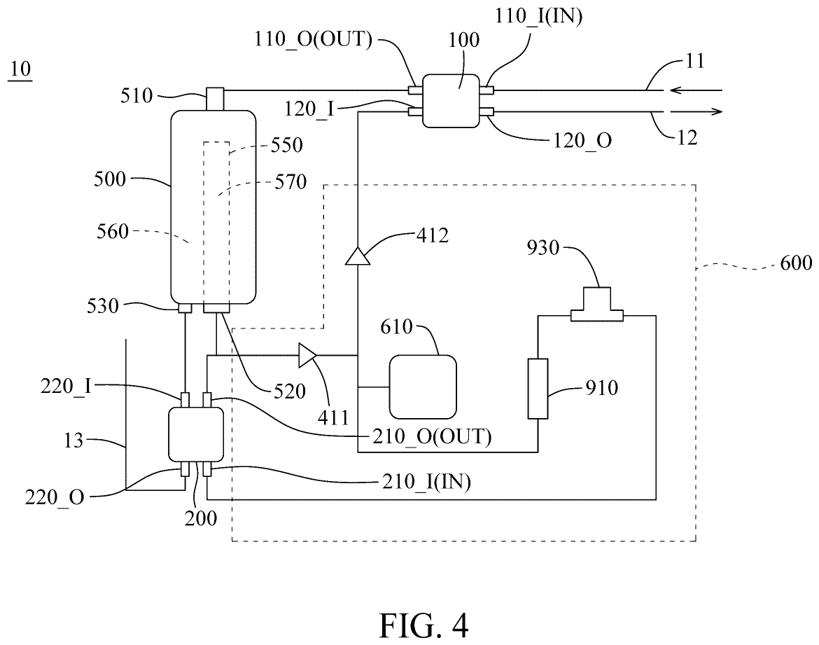

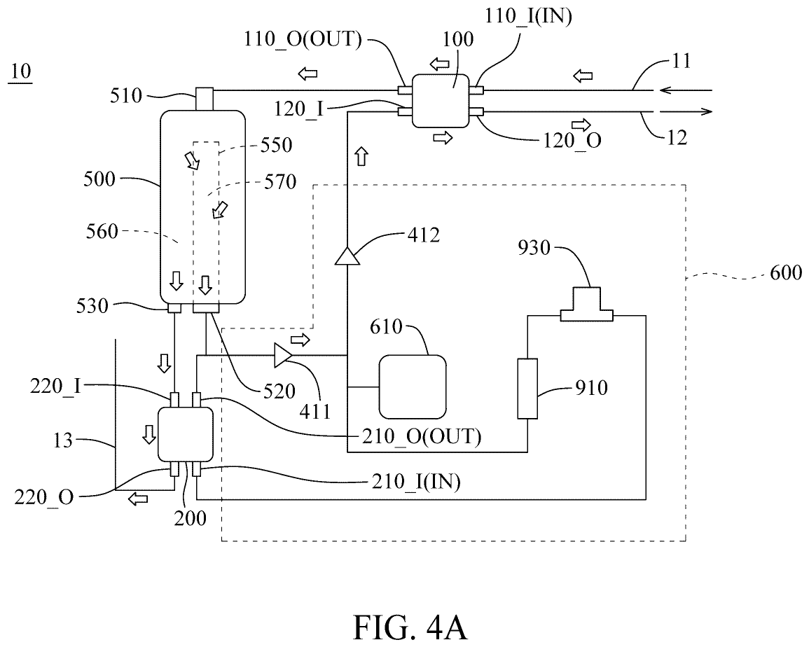

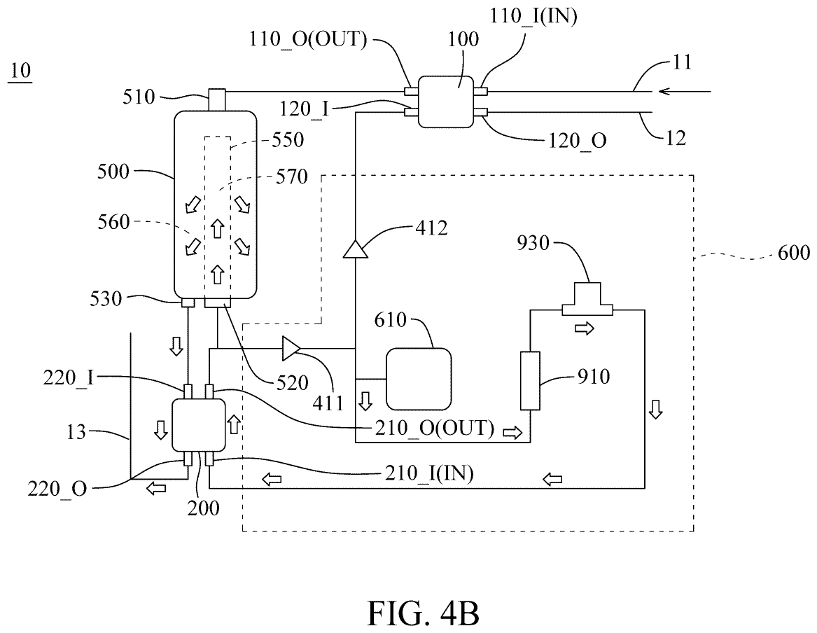

FIG. 4 shows a schematic diagram of configuration of a direct water purification system with an automatic backwash function according to a fourth embodiment of the present disclosure. FIG. 4A shows a schematic diagram of configuration of a direct water purification system with an automatic backwash function in a water purifying state according to the fourth embodiment of the present disclosure. FIG. 4B shows a schematic diagram of configuration of a direct water purification system with an automatic backwash function in a backwash state according to the fourth embodiment of the present disclosure.

Referring to FIG. 4, FIG. 4A and FIG. 4B, in one embodiment, the direct water purification system 10 with an automatic backwash function further includes an energy recovery homogenizing device 610, a first check valve 411, a pressure sensor 910 and an electromagnetic valve 930. The energy recovery homogenizing device 610 and the first check valve 411 are substantially the same as those described above, and related repeated details are omitted herein. The pressure sensor 910 is configured to sense the liquid pressure of the energy recovery homogenizing device 610 and/or an adjacent waterway. For example, the pressure sensor 910 can be configured at different positions of the energy recovery waterway 600, so as to sense changes in the liquid pressure at different positions in the energy recovery waterway 600. The electromagnetic valve 930 is disposed between the energy recovery homogenizing device 610 and the second water inlet valve 210_I(IN), and is configured to allow flow of liquid through the electromagnetic valve 930 when the liquid pressure sensed by the pressure sensor 910 has reached a fourth pressure threshold and to disallow flow of liquid through the electromagnetic valve 930 when the liquid pressure sensed by the pressure sensor 910 does not reach the fourth pressure threshold. The fourth pressure threshold is substantially the same as the pressure thresholds above, and can be adjusted according to actual application conditions.

In one embodiment, as shown in FIG. 4A, the direct water purification system 10 with an automatic backwash function above further includes a second check valve 412. The second check valve 412 is disposed among the first check valve 411, the energy recovery homogenizing device 610 and the first water inlet 120_I, such that purified water flows only in a direction away from the first check valve 411 and the energy recovery homogenizing device 610. Accordingly, as shown in FIG. 4B, the purified water having a higher liquid pressure stored at the energy recovery waterway 600 and/or in the energy recovery homogenizing device 610 flows only in a direction toward the second pressure valve 200. Moreover, with the second check valve 412 provided, the liquid pressure at the first water inlet 120_I and the first water outlet 120_O of the first pressure valve 100 is not reduced during a period of backwash, so that the energy recovery waterway 600 can output more purified water to back wash the filtration device 500, and that flow of liquid between the first water inlet valve 110_I(IN) and the first water outlet valve 110_O(OUT) is not restored and raw water is input to start water preparation too quickly.

Thus, as shown in FIG. 4B, substantially the same as the embodiments above, when the purified water outlet unit 12 is closed, the liquid pressure of purified water is continuously accumulated in the energy recovery homogenizing device 610 and/or the energy recovery waterway 600, such that the pressure of the liquid flowing through the first water inlet 120_I and the first water outlet 120_O reaches the first pressure threshold, and flow of liquid between the first water inlet valve 110_I(IN) and the first water outlet valve 110_O(OUT) is disallowed. Next, due to the disconnection of the input of raw water, water preparation stops, such that the liquid pressure of waste water flowing through the second water inlet 220_I and the second water outlet 220_O does not reach the second pressure threshold, and flow of liquid between the second water inlet valve 210_I(IN) and the second water outlet valve 210_O(OUT) is allowed. Meanwhile, due to the liquid pressure of purified water accumulated during the time difference when the water preparation above is not fully stopped, when the pressure sensor 901 senses that the liquid pressure in the energy recovery homogenizing device 610 and/or the energy recovery waterway 600 has reached the fourth pressure threshold, flow of liquid through the electromagnetic valve 930 is allowed, such that the purified water in the energy recovery homogenizing device 610 and/or the energy recovery waterway 600 back flows via the electromagnetic valve 930, the second water inlet valve 210_I(IN) and the second water outlet valve 210_O(OUT) to the filtered water outlet 520, and back washes the filtration component 550. It should be noted that, the electromagnetic valve 930 is not limited to being an electromagnetic valve, and any device capable of adjusting whether to allow or disallow flow of liquid by means of electrical or mechanical control according to the pressure sensor 910 is encompassed within the scope of the present disclosure.

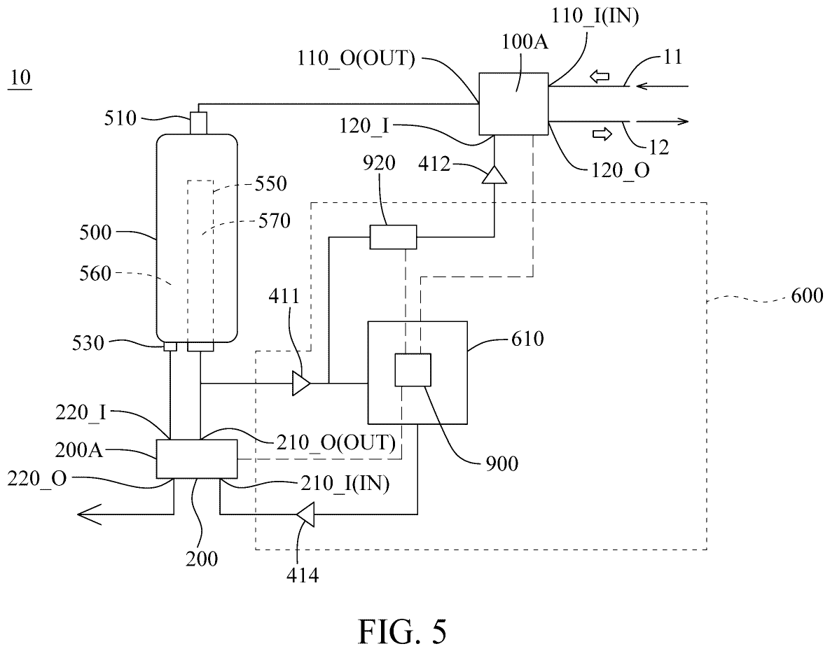

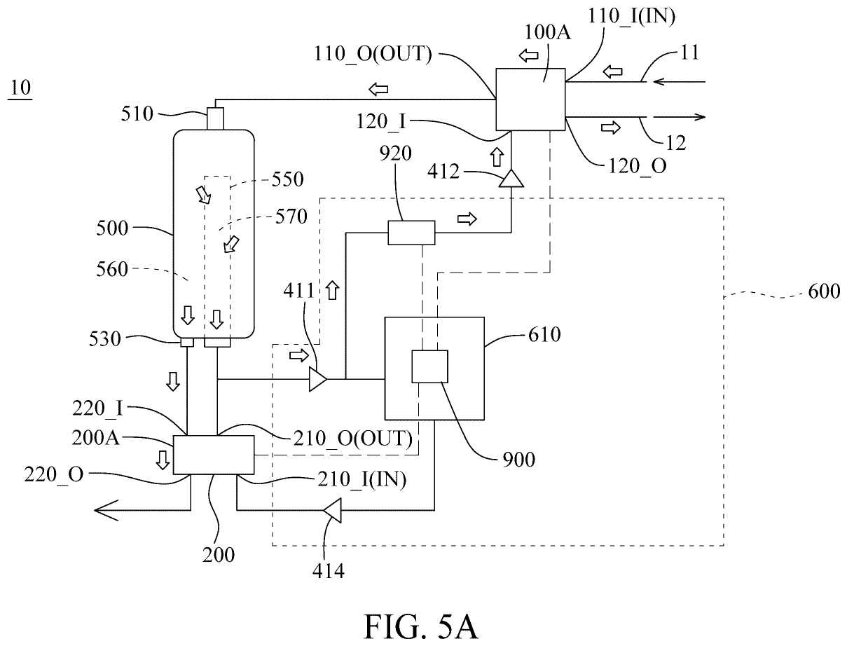

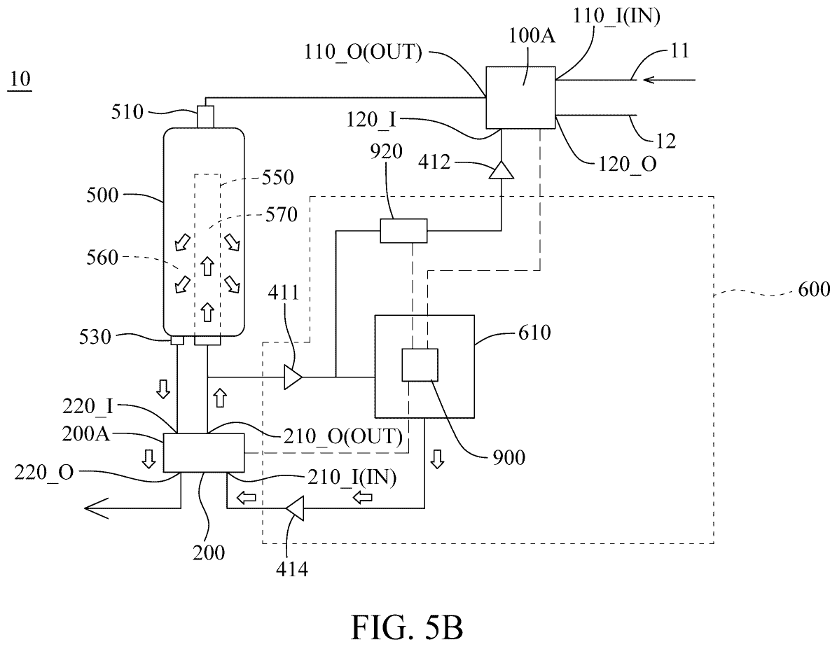

FIG. 5 shows a schematic diagram of configuration of a direct water purification system with an automatic backwash function according to a fifth embodiment of the present disclosure. FIG. 5A shows a schematic diagram of configuration of a direct water purification system with an automatic backwash function in a water purifying state according to the fifth embodiment of the present disclosure. FIG. 5B shows a schematic diagram of configuration of a direct water purification system with an automatic backwash function in a backwash state according to the fifth embodiment of the present disclosure.

Referring to FIG. 5, FIG. 5A and FIG. 5B, a direct water purification system 10 with an automatic backwash function is further provided according to an aspect of the present disclosure. The direct water purification system 10 with an automatic backwash function includes a raw water inlet unit 11, a first control valve 100A, a filtration device 500, a second control valve 200A, a purified water outlet unit 12, a waste water outlet unit 13, an energy recovery waterway 600, an energy recovery homogenizing device 610, a flow sensor 920 and a controller 900. Functional mechanisms of the raw water inlet unit 11, the filtration device 500, the purified water outlet unit 12, the waste water outlet unit 13, the energy recovery waterway 600 and the energy recovery homogenizing device 610 are substantially the same as those described in the embodiments above, and related repeated details are omitted herein.

The flow sensor 920 is configured to sense flow of a liquid output to the purified water outlet unit 12. The controller 900 is electrically connected to the energy recovery homogenizing device 610 and the flow sensor 920, and is configured to have the energy recovery homogenizing device 610 output purified water when the flow sensor 920 detects that the flow of the liquid is decreased. A difference from the embodiments above is that, purified water output for backwash is output by the energy recovery homogenizing device 610 according to the controller 900.

In one embodiment, the first control valve 100A and the second control valve 200A are electrically connected to the controller 900, and are configured to control flow of liquid between the first water inlet valve 110_I(IN) and the first water outlet valve 110_O(OUT) of the first control valve 100A by the controller 900, and to control flow of liquid between the second water inlet valve 210_I(IN) and the second water outlet valve 210_O(OUT) of the second control valve 200A by the controller 900. Accordingly, changes of flow in a waterway can be completely monitored by the controller 900, and flow of liquids through the individual control valves can be controlled by the controller 900.

In one embodiment, the controller 900 is configured to be signally connected to an external device (not shown), and can be monitored, set or controlled externally. In one embodiment, the controller 900 may be an apparatus such as a smartphone, a desktop computer, a laptop computer, a tablet computer, a workstation, a server, a cloud server or a computing device. The controller 900 may be provided with a user interface for operation by a user, or may be indirectly operated or controlled by other electronic devices and external devices by means of electrical signal transmission with other electronic devices and other external devices. In addition, related electrically controlled elements such as the controller 900 may be further provided with an input module and an output module to provide a visual and/audio user interface, such as a display, a touch screen, a projector, a speaker, telephone audio, a keyboard, a mouse, motion detection and voice recognition, as a medium for control and setting.

In one embodiment, the direct water purification system 10 with an automatic backwash function further includes a first check valve 411, a second check valve 412 and a fourth check valve 414. The first check valve 411 is disposed among the filtered water outlet 520, the second water outlet valve 210_O(OUT), the energy recovery homogenizing device 610 and the first water inlet 120_I, such that purified water flows only in a direction away from the filtered water outlet 520 and the second water outlet valve 210_O(OUT). The second check valve 412 is disposed among the first check valve 411, the energy recovery homogenizing device 610 and the first water inlet 120_I, such that purified water flows only in a direction away from the first check valve 411 and the energy recovery homogenizing device 610. The fourth check valve 414 is disposed between the energy recovery homogenizing device 610 and the second water inlet valve 210_I(IN), such that purified water flows only in a direction away from the energy recovery homogenizing device 610. Thus, the directionality of the purified water output by the energy recovery homogenizing device 610 can be provided, and the purified water output by the energy recovery homogenizing device 610 can be controlled to be output in a supplement manner to the purified water outlet unit 12 in the water purifying state, and be output to the filtration device 500 in the backwash state

In one embodiment, the first control valve 100A is configured to disallow flow of liquid between the first water inlet valve 110_I(IN) and the first water outlet valve 110_O(OUT) when pressure of a liquid flowing through the first water inlet 120_I and the first water outlet 120_O has reached a first pressure threshold, and to allow flow of liquid between the first water inlet valve 110_I(IN) and the first water outlet valve 110_O(OUT) when the pressure of the liquid flowing through the first water inlet 120_I and the first water outlet 120_O does not reach the first pressure threshold; and the second control valve 200A is configured to disallow flow of liquid between the second water inlet valve 210_I(IN) and the second water outlet valve 210_O(OUT) when pressure of a liquid flowing through the second water inlet 220_I and the second water outlet 220_O has reached a second pressure threshold, and to allow flow of liquid between the second water inlet valve 210_I(IN) and the second water outlet valve 210_O(OUT) when the pressure of the liquid flowing through the second water inlet 220_I and the second water outlet 220_O does not reach the second pressure threshold. Thus, flow through the individual control valves can be controlled by the passive liquid pressure, and is not limited to being controlled by the controller 900.

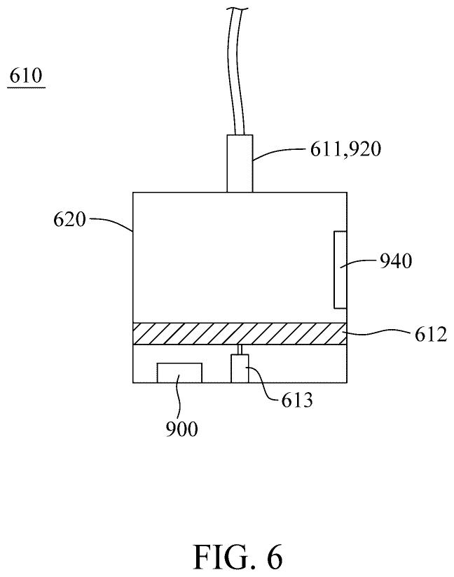

FIG. 6 shows a schematic diagram of configuration of an energy recovery homogenizing device of a direct water purification system with an automatic backwash function according to an embodiment of the present disclosure.

Referring to FIG. 6, in one embodiment, the energy recovery homogenizing device 610 further includes a cavity 620, a valve 611, a flow sensor 920, a water level sensor 940, a partition board 612 and a level shifter 613. The cavity 620 is configured to accommodate purified water and for arrangement of related elements. The valve 611 is disposed at the cavity 620, and enables the cavity 620 to selectively be in liquid communication with a waterway connected to the energy recovery homogenizing device 610. The flow sensor 920 is disposed at the valve 611, and is configured to sense the flow of liquid flowing through the valve 611. The water level sensor 940 is disposed in the cavity 620, and is configured to sense a water level in the cavity 620. The partition board 612 is disposed in the cavity 620, and is configured to be movable to change volume of the cavity 620 and to regulate liquid pressure of purified water. The level shifter 613 is disposed in the cavity 620, and is configured to be controlled by the controller 900 to adjust a position of the partition board 612. In one embodiment, the level shifter 613 is a thruster. Thus, with the integration into the controller 900 above, water amount monitoring, water level monitoring and regulation and control for input and output purified water of the energy recovery homogenizing device 610 can be performed.

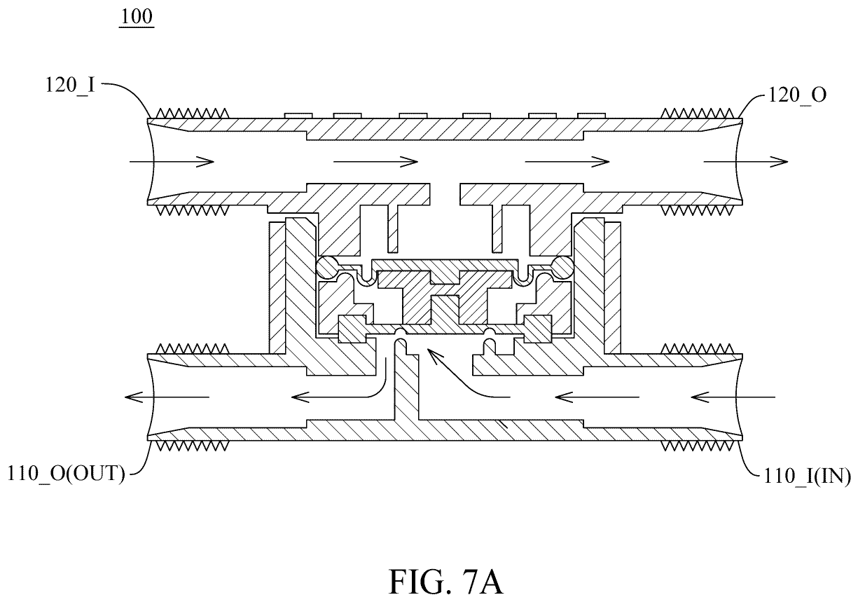

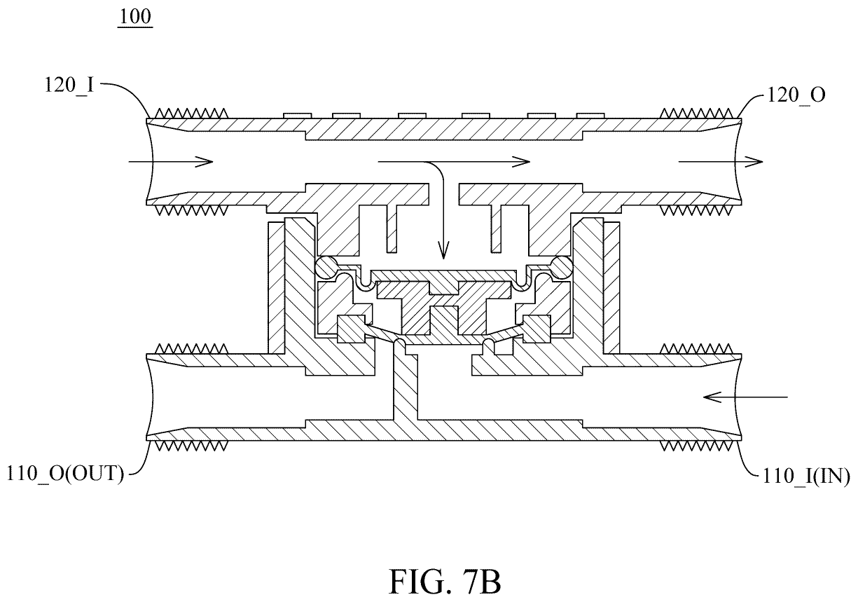

FIG. 7A shows a schematic diagram of configuration of flow of liquid allowed on both sides of pressure valves of a direct water purification system with an automatic backwash function according to an embodiment of the present disclosure. FIG. 7B shows a schematic diagram of configuration of flow of liquid disallowed on one side of pressure valves of a direct water purification system with an automatic backwash function according to an embodiment of the present disclosure.

As shown in FIG. 7A and FIG. 7B, taking the first pressure valve 100 for example, the first pressure valve 100 is configured to allow flow of liquid between the first water inlet valve 110_I(IN) and the first water outlet valve 110_O(OUT) when the pressure of the liquid flowing through the first water inlet 120_I and the first water outlet 120_O does not reach the first pressure threshold, as shown in FIG. 7A. However, flow of liquid between the first water inlet valve 110_I(IN) and the first water outlet valve 110_O(OUT) is disallowed when the pressure of the liquid flowing through the first water inlet 120_I and the first water outlet 120_O has reached the first pressure threshold, as shown in FIG. 7B. At this point in time, the state of liquid flow between the first water inlet 120_I and the first water outlet 120_O is maintained.

In conclusion, by the direct water purification system with an automatic backwash function of the present disclosure, each time the water purification system outputs purified water, backwash for the filtration component can be automatically performed, without needing other operations or settings of a user, without any additional pump or power input for powering backwash under use of configuration of a waterway using pressure valves, without involving large-capacity purified water storage tanks and without flowing through a raw water pipeline that may again bring contaminants to a filtration device. With the liquid pressure of purified water quickly accumulated during a time difference between preparing of purified water in the water purifying state and closing of the output of purified water, the switch of backwash can be automatically turned on by the liquid pressure of purified water accumulated during the time difference. Thus, the filtration component, each time it is used, can be automatically cleaned by back flushing from the purified water end to the concentrated water end, and contaminants filtered out on the filtration component can be effectively removed, hence achieving effects of maintaining the TDS stability of purified water output and cleanliness of purified water for an extended period of time. Moreover, with the controller and related sensing devices provided, the switch for backwash can be automatically turned on by means of sensing the flow, so that automatic cleaning can be performed after each use. In addition, with the control valve and the controllable energy recovery homogenizing device, the backwash procedure can be further automatically and flexibly adjusted to assist in output of purified water.

The present disclosure is described by way of the preferred embodiments above. A person skilled in the art should understand that, these embodiments are merely for illustrating the present invention and are not to be construed as limitations to the scope of the present disclosure. It should be noted that all equivalent changes, replacements and substitutions made to the embodiments are encompassed within the scope of the present disclosure, and the embodiments above may be combined or modified by any means as desired. Therefore, the legal protection for the present disclosure should be defined by the appended claims.

While the present disclosure has been described by means of specific embodiments, numerous modifications and variations could be made thereto by those skilled in the art without departing from the scope and spirit of the present disclosure set forth in the claims.

What is claimed is:

1. A direct water purification system with an automatic backwash function, comprising:
a raw water inlet unit, configured to receive raw water from an exterior;
a first pressure valve, comprising:
a first water inlet valve, in liquid communication with the raw water inlet unit;
a first water outlet valve;
a first water inlet; and
a first water outlet, in liquid communication with the first water inlet;
wherein, the first pressure valve is configured to disallow flow of liquid between the first water inlet valve and the first water outlet valve when pressure of a liquid flowing through the first water inlet and the first water outlet has reached a first pressure threshold, and to allow flow of liquid between the first water inlet valve and the first water outlet valve when the pressure of the liquid flowing through the first water inlet and the first water outlet does not reach the first pressure threshold;
a filtration device, comprising:
a filtered water inlet, in liquid communication with the first water outlet valve to receive the raw water;
a filtration component, configured to filter and separate the raw water into purified water and waste water;
a filtered water outlet, configured to output the purified water obtained from filtering by the filtration component; and
a filtered waste water outlet, configured to output the waste water separated by the filtration component;
a second pressure valve, comprising:
a second water inlet valve;
a second water outlet valve;
a second water inlet, in liquid communication with the filtered waste water outlet; and
a second water outlet, in liquid communication with the second water inlet;
wherein, the second pressure valve is configured to disallow flow of liquid between the second water inlet valve and the second water outlet valve when pressure of a liquid flowing through the second water inlet and the second water outlet has reached a second pressure threshold, and to allow flow of liquid between the second water inlet valve and the second water outlet valve when the pressure of the liquid flowing through the second water inlet and the second water outlet does not reach the second pressure threshold;
a purified water outlet unit, in liquid communication with the first water outlet, configured to output the purified water to the exterior;
a waste water outlet unit, in liquid communication with the second water outlet, configured to output the waste water to the exterior; and
an energy recovery waterway, in liquid communication with the filtered water outlet, the second water outlet valve, the second water inlet valve and the first water inlet;
wherein, the energy recovery waterway is configured to collect the purified water and accumulate pressure when the purified water outlet unit is closed, and to back flow the purified water by the accumulated pressure to the filtered water outlet so as to clean the filtration component.

2. The direct water purification system with an automatic backwash function according to claim 1, wherein when the purified water outlet unit is closed, the pressure of the liquid flowing through the first water inlet and the first water outlet reaches the first pressure threshold and flow of liquid between the first water inlet valve and the first water outlet valve is disallowed, and the pressure of the liquid flowing through the second water inlet and the second water outlet does not reach the second pressure threshold and flow of liquid between the second water inlet valve and the second water outlet valve is allowed, such that the purified water in the energy recovery waterway back flows to the filtered water outlet and cleans the filtration component.

3. The direct water purification system with an automatic backwash function according to claim 1, when the purified water outlet unit is open, the pressure of the liquid flowing through the first water inlet and the first water outlet does not reach the first pressure threshold and flow of liquid between the first water inlet valve and the first water outlet valve is allowed, and the pressure of the liquid flowing through the second water inlet and the second water outlet reaches the second pressure threshold and flow of liquid between the second water inlet valve and the second water outlet valve is disallowed, such that the purified water output from the filtered water outlet flows forward to the purified water outlet unit.

4. The direct water purification system with an automatic backwash function according to claim 1, wherein the purified water back flowing to the filtered water outlet flows from a purified water region in the filtration device to a raw water region and is discharged via the filtered waste water outlet.

5. The direct water purification system with an automatic backwash function according to claim 1, further comprising:
an energy recovery homogenizing device, configured in the energy recovery waterway, adapted to regulate liquid pressure of the purified water; and
a first check valve, disposed among the filtered water outlet, the second water outlet valve, the energy recovery homogenizing device and the first water inlet, such that the purified water flows only in a direction away from the filtered water outlet and the second water outlet valve.

6. The direct water purification system with an automatic backwash function according to claim 5, further comprising:
a second check valve, disposed among the first check valve, the energy recovery homogenizing device and the first water inlet, such that the purified water flows only in a direction away from the first check valve and the energy recovery homogenizing device.

7. The direct water purification system with an automatic backwash function according to claim 5, wherein when the purified water outlet unit is closed, the liquid pressure of the purified water continuously accumulates in the energy recovery homogenizing device, such that the pressure of the liquid flowing through the first water inlet and the first water outlet reaches the first pressure threshold, and flow of liquid between the first water inlet valve and the first water outlet valve is disallowed; such that the pressure of the liquid flowing through the second water inlet and the second water outlet does not reach the second pressure threshold, and flow of liquid between the second water inlet valve and the second water outlet valve is allowed; and such that the purified water in the energy recovery homogenizing device back flows to the filtered water outlet via the second water inlet valve and the second water outlet valve and cleans the filtration component.

8. The direct water purification system with an automatic backwash function according to claim 1, further comprising:
an energy recovery homogenizing device, configured in the energy recovery waterway, adapted to regulate liquid pressure of the purified water;
a first check valve, disposed among the filtered water outlet, the second water outlet valve, the energy recovery homogenizing device and the first water inlet, such that the purified water flows only in a direction away from the filtered water outlet and the second water outlet valve; and
a third pressure valve, comprising:
a third water inlet valve, in liquid communication with the energy recovery homogenizing device;
a third water outlet valve, in liquid communication with the second water inlet valve;
a third water inlet, in liquid communication with the first water inlet; and
a third water outlet, in liquid communication with the purified water outlet unit;
wherein, the third pressure valve is configured to allow flow of liquid between the third water inlet valve and the third water outlet valve when pressure of a liquid flowing through the third water inlet and the third water outlet has reached a third pressure threshold, and to disallow flow of liquid between the third water inlet valve and the third water outlet valve when the pressure of the liquid flowing through the third water inlet and the third water outlet does not reach the third pressure threshold.

9. The direct water purification system with an automatic backwash function according to claim 8, further comprising:
a second check valve, disposed among the first check valve, the energy recovery homogenizing device and the first water inlet, such that the purified water flows only in a direction away from the first check valve and the energy recovery homogenizing device.

10. The direct water purification system with an automatic backwash function according to claim 8, further comprising:
a pressure reducing valve, disposed between the first water outlet and the third water inlet, configured to have liquid pressure at an end of the third water inlet be less than that at an end of the first water outlet; and
a third check valve, disposed between the third water outlet and the purified water outlet unit, such that the purified water flows only in a direction away from the third water outlet.

11. The direct water purification system with an automatic backwash function according to claim 8, wherein when the purified water outlet unit is closed, the liquid pressure of the purified water continuously accumulates in the energy recovery homogenizing device, such that the pressure of the liquid flowing through the first water inlet and the first water outlet reaches the first pressure threshold, and flow of liquid between the first water inlet valve and the first water outlet valve is disallowed; such that the pressure of the liquid flowing through the second water inlet and the second water outlet does not reach the second pressure threshold, and flow of liquid between the second water inlet valve and the second water outlet valve is allowed; such that the pressure of the liquid flowing through the third water inlet and the third water outlet reaches the third pressure threshold, and flow of liquid between the third water inlet valve and the third water outlet valve is allowed; and such that the purified water in the energy recovery homogenizing device back flows to the filtered water outlet via the third water inlet valve, the third water outlet valve, the second water inlet valve and the second water outlet valve and cleans the filtration component.

12. The direct water purification system with an automatic backwash function according to claim 1, further comprising:
an energy recovery homogenizing device, configured in the energy recovery waterway, adapted to regulate liquid pressure of the purified water;
a first check valve, disposed among the filtered water outlet, the second water outlet valve, the energy recovery homogenizing device and the first water inlet, such that the purified water flows only in a direction away from the filtered water outlet and the second water outlet valve;
a pressure sensor, configured to sense liquid pressure of the energy recovery homogenizing device and/or an adjacent waterway; and
an electromagnetic valve, disposed between the energy recovery homogenizing device and the second water inlet valve, configured to allow flow of liquid through the electromagnetic valve when the liquid pressure sensed by the pressure sensor has reached a fourth pressure threshold, and to disallow flow of liquid through the electromagnetic valve when the liquid pressure sensed by the pressure sensor does not reach the fourth pressure threshold.

13. The direct water purification system with an automatic backwash function according to claim 12, further comprising:
a second check valve, disposed among the first check valve, the energy recovery homogenizing device and the first water inlet, such that the purified water flows only in a direction away from the first check valve and the energy recovery homogenizing device.

14. The direct water purification system with an automatic backwash function according to claim 12, when the purified water outlet unit is closed, the liquid pressure of the purified water continuously accumulates in the energy recovery homogenizing device, such that the pressure of the liquid flowing through the first water inlet and the first water outlet reaches the first pressure threshold, and flow of liquid between the first water inlet valve and the first water outlet valve is disallowed; such that the pressure of the liquid flowing through the second water inlet and the second water outlet does not reach the second pressure threshold, and flow of liquid between the second water inlet valve and the second water outlet valve is allowed; and the liquid pressure of the energy recovery homogenizing device sensed by the pressure sensor reaches the fourth pressure threshold, such that flow of liquid through the electromagnetic valve is allowed, and the purified water in the energy recovery homogenizing device back flows to the filtered water outlet via the electromagnetic valve, the second water inlet valve and the second water outlet valve and cleans the filtration component.

15. A direct water purification system with an automatic backwash function, comprising:
a raw water inlet unit, configured to receive raw water from an exterior;
a first control valve, comprising:
a first water inlet valve, in liquid communication with the raw water inlet unit;
a first water outlet valve;
a first water inlet; and
a first water outlet, in liquid communication with the first water inlet;
a filtration device, comprising:
a filtered water inlet, in liquid communication with the first water outlet valve to receive the raw water;
a filtration component, configured to filter and separate the raw water into purified water and waste water;
a filtered water outlet, configured to output the purified water obtained from filtering by the filtration component; and
a filtered waste water outlet, configured to output the waste water separated by the filtration component;
a second control valve, comprising:
a second water inlet valve;
a second water outlet valve;
a second water inlet, in liquid communication with the filtered waste water outlet; and
a second water outlet, in liquid communication with the second water inlet;
a purified water outlet unit, in liquid communication with the first water outlet, configured to output the purified water to the exterior;
a waste water outlet unit, in liquid communication with the second water outlet, configured to output the waste water to the exterior;
an energy recovery waterway, in liquid communication with the filtered water outlet, the second water outlet valve, the second water inlet valve and the first water inlet;
an energy recovery homogenizing device, configured in the energy recovery waterway, adapted to regulate liquid pressure of the purified water;
a flow sensor, configured to sense flow of a liquid output to the purified water outlet unit; and
a controller, electrically connected to the energy recovery homogenizing device and the flow sensor, configured to have the energy recovery homogenizing device output the purified water when the flow sensor detects that the flow of the liquid is decreased.

16. The direct water purification system with an automatic backwash function according to claim 15, wherein the first control valve and the second control valve are electrically connected to the controller, and are configured to control flow of liquid between the first water inlet valve and the first water outlet valve of the first control valve by the controller, and to control flow of liquid between the second water inlet valve and the second water outlet valve of the second control valve by the controller.

17. The direct water purification system with an automatic backwash function according to claim 15, further comprising:
a first check valve, disposed among the filtered water outlet, the second water outlet valve, the energy recovery homogenizing device and the first water inlet, such that the purified water flows only in a direction away from the filtered water outlet and the second water outlet valve;
a second check valve, disposed among the first check valve, the energy recovery homogenizing device and the first water inlet, such that the purified water flows only in a direction away from the first check valve and the energy recovery homogenizing device; and
a fourth check valve, disposed between the energy recovery homogenizing device and the second water inlet valve, such that the purified water flows only in a direction away from the energy recovery homogenizing device.

18. The direct water purification system with an automatic backwash function according to claim 15, wherein:
the first control valve is configured to disallow flow of liquid between the first water inlet valve and the first water outlet valve when pressure of a liquid flowing through the first water inlet and the first water outlet has reached a first pressure threshold, and to allow flow of liquid between the first water inlet valve and the first water outlet valve when the pressure of the liquid flowing through the first water inlet and the first water outlet does not reach the first pressure threshold; and
the second control valve is configured to disallow flow of liquid between the second water inlet valve and the second water outlet valve when pressure of a liquid flowing through the second water inlet and the second water outlet has reached a second pressure threshold and to allow flow of liquid between the second water inlet valve and the second water outlet valve when the pressure of the liquid flowing through the second water inlet and the second water outlet does not reach the second pressure threshold.

19. The direct water purification system with an automatic backwash function according to claim 15, wherein the energy recovery homogenizing device further comprises:
a cavity;
a valve, disposed at the cavity, enabling the cavity to selectively be in liquid communication with a waterway connected to the energy recovery homogenizing device;
a flow sensor, disposed at the valve, configured to sense flow of a liquid flowing through the valve;
a water level sensor, disposed in the cavity, configured to sense a water level within the cavity;
a partition board, disposed in the cavity, configured to be movable to change volume of the cavity; and
a level shifter, disposed in the cavity, configured to be controlled by the controller to adjust a position of the partition board.
